(19) United States
(12) Patent Application Publication
(10) Pub. No.: US 2013/0155467 A1
(43) Pub. Date: Jun. 20, 2013

(54) IMAGE FORMING APPARATUS, IMAGE FORMING METHOD, AND COMPUTER-READABLE RECORDING MEDIUM

(71) Applicant: Akiyoshi NAKAI, Kanagawa (JP)

(72) Inventor: Akiyoshi NAKAI, Kanagawa (JP)

(21) Appl. No.: 13/710,926

(22) Filed: Dec. 11, 2012

(30) Foreign Application Priority Data
Dec. 14, 2011 (JP) 2011-273258

(51) Int. Cl. G06K 15/14

(52) U.S. Cl. CPC G06K 15/14
USPC 358/3.06

(57) ABSTRACT

Disclosed is an image forming apparatus, including a pattern holding part configured to hold patterns with predetermined shapes and densities dependent on a brightness of a color image, and a control part configured to determine a brightness of a color area of the color image, select a pattern with a predetermined shape corresponding to the determined brightness from the patterns held in the pattern holding part, replace the color area with the selected pattern with a predetermined shape, convert the color image with the selected pattern with a predetermined shape into a monochromatic image, and output the monochromatic image.

### BACKGROUND OF THE INVENTION

1. Field of the Invention

An aspect of the present invention relates to at least one of an image forming apparatus, an image forming method, and a computer-readable recording medium.

2. Description of the Related Art

When a printer or a copier is used, there are many cases where printing is conducted monochromatically at a low cost even for a color original document. Accordingly, there is a technique whereby it is possible to identify a color portion of an original document even if printing is conducted monochromatically.

For example, in Japanese Patent Application Publication No. 11-017961, when a color original document is printed monochromatically, a specific pattern is assigned to a color portion of the original document to identify a color difference so that such a color portion of the original document is identified.

However, it is possible for a color identifying technique as described above to identify a color difference in an original document but there is a problem in that it is not possible to identify shading of a color if there is shading of a color (for example, a light red and a dark red, etc.).

### SUMMARY OF THE INVENTION

According to one aspect of the present invention, there is provided an image forming apparatus, including a pattern holding part configured to hold patterns with predetermined shapes and densities dependent on a brightness of a color image, and a control part configured to determine a brightness of a color area of the color image, select a pattern with a predetermined shape corresponding to the determined brightness from the patterns held in the pattern holding part, replace the color area with the selected pattern with a predetermined shape, convert the color image with the selected pattern with a predetermined shape into a monochromatic image, and output the monochromatic image.

According to another aspect of the present invention, there is provided an image forming apparatus, including a pattern holding part configured to hold predetermined patterns with shapes and densities dependent on a brightness and a hue of a color image, and a control part configured to determine a brightness and a hue of a color area of the color image, select a predetermined pattern corresponding to the determined brightness and hue from the predetermined patterns held in the pattern holding part, replace the color area with the selected predetermined pattern, convert the color image with the selected predetermined pattern into a monochromatic image, and output the monochromatic image.

According to another aspect of the present invention, there is provided an image forming method, including steps of holding a pattern with a predetermined shape and a density dependent on a brightness of a color image, determining a brightness of a color area of the color image, selecting a pattern with a predetermined shape corresponding to the determined brightness, replacing the color area with the selected pattern with a predetermined shape, converting the color image with the selected pattern with a predetermined shape into a monochromatic image, and outputting the monochromatic image.

According to another aspect of the present invention, there is provided a non-transitory computer-readable recording medium storing a computer program configured to cause a computer to execute the image forming method as described above.

### BRIEF DESCRIPTION OF THE DRAWINGS

FIG. 1 is a diagram illustrating a relationship between brightness and pattern density in an embodiment of the present invention.

FIG. 2 is a diagram illustrating a relationship between hue and pattern shape in an embodiment of the present invention.

FIG. 3 is a diagram illustrating a relationship between a hue or a brightness and a pattern density or shape in an embodiment of the present invention.

FIG. 4A, FIG. 4B, FIG. 4C, FIG. 4D, and FIG. 4E are diagrams illustrating a pattern replacement process for a character on a colored background in an embodiment of the present invention.

FIG. 5A and FIG. 5B are diagrams illustrating another example of improving visibility of a character in an embodiment of the present invention.

FIG. 6 is a diagram illustrating a configuration of an image forming apparatus according to Practical Example 1 in an embodiment of the present invention.

FIG. 7 is a diagram illustrating a configuration of an image forming apparatus according to Practical Example 2 in an embodiment of the present invention.

FIG. 8 is a diagram illustrating a flowchart for a process in Practical Example 2.

FIG. 9A and FIG. 9B are diagrams illustrating an example of reduction in an amount of attached toner.

FIG. 10 is a diagram illustrating a flowchart for a process in Practical Example 3.

FIG. 11A, FIG. 11B, and FIG. 11C are diagrams illustrating a process in Practical example 3.

FIG. 12 is a diagram illustrating an example of a configuration of Practical Example 4.

### DETAILED DESCRIPTION OF THE PREFERRED EMBODIMENTS

An embodiment of the invention will be described in detail below with reference to the drawings. In an embodiment of the present invention, when a color original document is printed monochromatically, a shading difference of a color portion of the original document is identified by changing density of a pattern depending on brightness of the original document.

### Practical Example 1

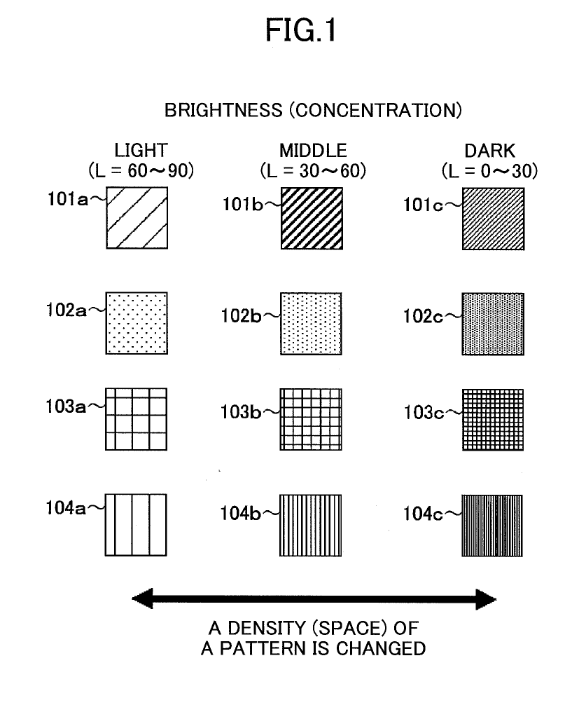

FIG. 1 is a diagram illustrating a relationship between brightness and pattern density in an embodiment of the present invention. As illustrated in FIG. 1, patterns 101a-104a, 101b-104b, and 101c-104c provided by changing spaces between lines or dots forming a diagonal line pattern 101, a dot pattern 102, a grid pattern 103, and a vertical line pattern 104 are preliminarily prepared (held), and a pattern density is switched depending on a difference in brightness (L). For example, a difference in brightness in input data is distinguished by narrowing spaces between lines or dots (101c-104c) for an area with a small L (L=0-30) or broadening the spaces between lines or dots (101a-104a) for an area with a large L (L=60-90), as illustrated in FIG. 1. Although brightness (concentration) is divided into three for illustration herein, the division may be conducted more finely.

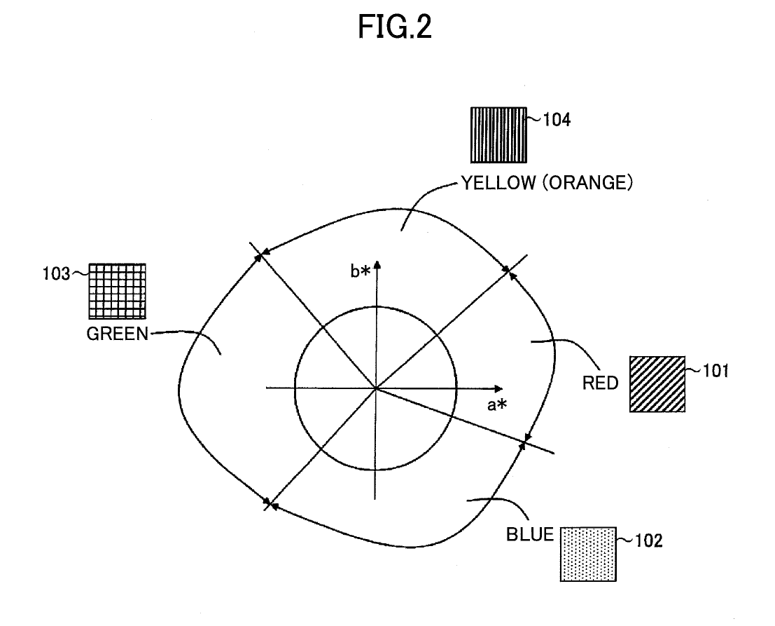

FIG. 2 is a diagram illustrating a relationship between hue and pattern shape in an embodiment of the present invention. As illustrated in FIG. 2, hue is divided into four (for example, red, yellow (orange), green, and blue) in an a* b* chromaticity diagram, and a specific pattern is preliminarily assigned to each divided hue. Herein, a diagonal line pattern 101, a dot pattern 102, a grid pattern 103, and a vertical line pattern 104 are assigned to red, to blue, to green, and to yellow (orange), respectively. Thereby, it may be easy for a user to always understand which pattern indicates what color.

Although division into four hues is conducted for illustration herein, division may be conducted more finely. Furthermore, although illustration is provided on an a* b* plane, division on another color system or color space such as a Lab color space, XYZ, or YCC may be conducted.

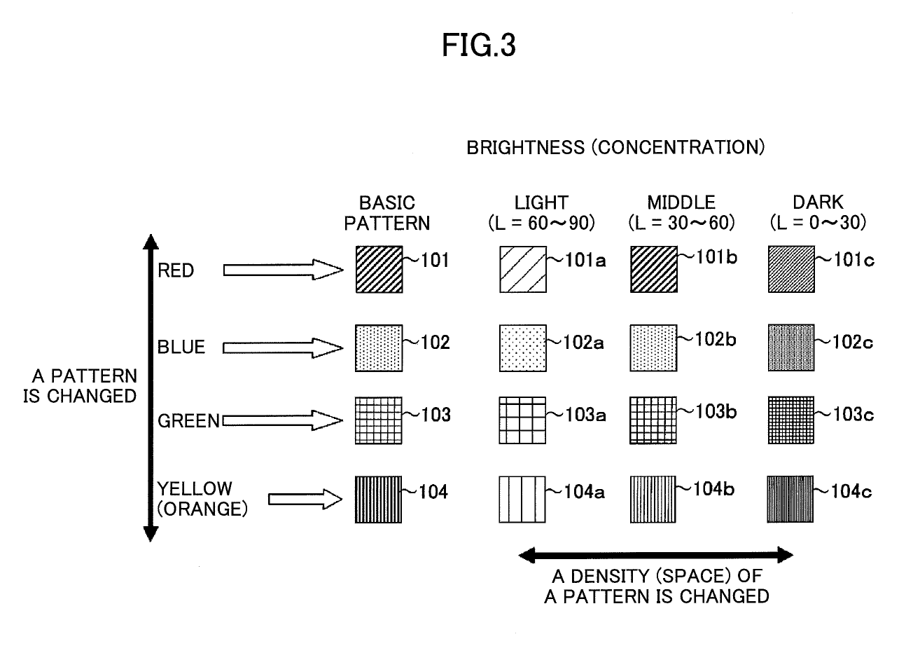

FIG. 3 is a diagram illustrating a relationship between hue or brightness and pattern density or shape in an embodiment of the present invention. A basic pattern (101-104) is assigned which corresponds to a hue (red, blue, green, or yellow (orange)), and a density (space) of a basic pattern is changed depending on brightness, whereby it is possible to represent a brightness difference (concentration difference) for an identical hue. Furthermore, red and pink have an identical hue and a different brightness whereby it is possible to represent a different color difference in an identical hue. Thereby, it is possible to identify a brightness difference when a chromatic original document is printed monochromatically.

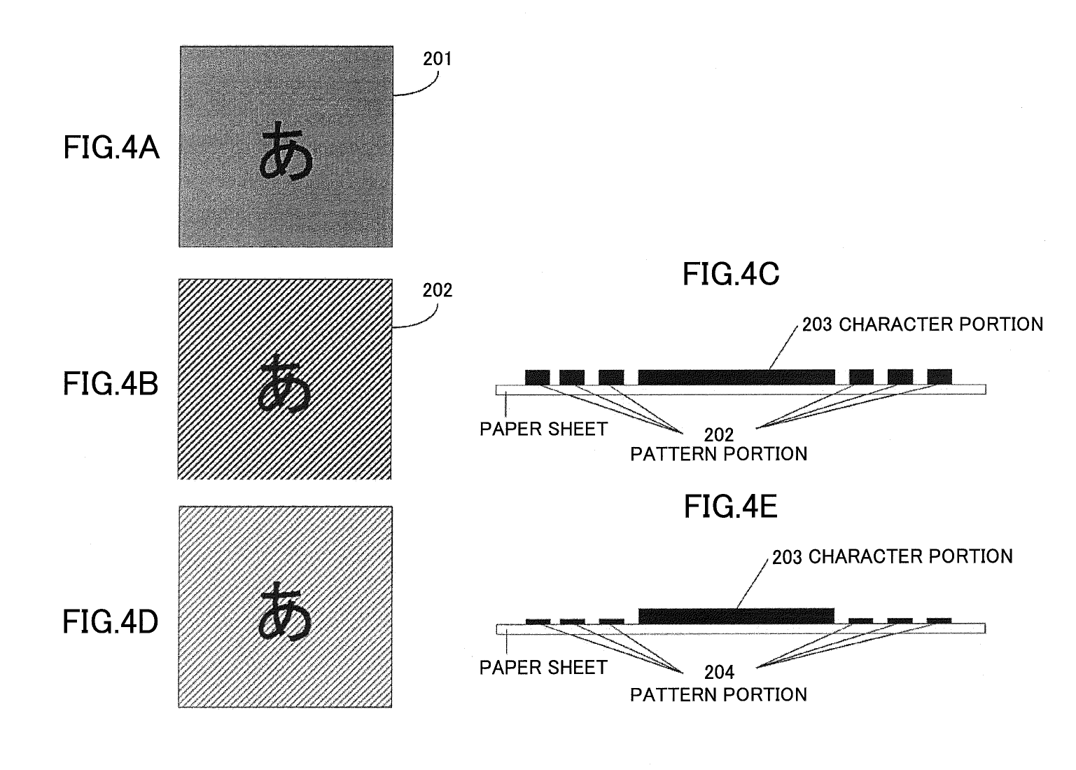

FIG. 4A, FIG. 4B, FIG. 4C, FIG. 4D, and FIG. 4E are diagrams illustrating a pattern replacement process for a character on a colored background in an embodiment of the present invention. In a case where there is a character on a colored background as illustrated in FIG. 4A, when a colored background portion 201 is simply replaced with a pattern portion 202, concentrations of a character portion 203 and the pattern portion 202 are identical as illustrated in FIG. 4B and FIG. 4C, and accordingly, visibility of a 1E character may be degraded. FIG. 4C illustrates a cross-section of FIG. 4D.

Hence, in a case where there is a character on a colored background in an embodiment of the present invention, an amount of attached toner for a line or a dot which forms a replacing pattern portion 204 is reduced to be less than that of the character portion 203 without changing an amount of toner on the character portion 203 as illustrated in FIG. 4D and FIG. 4E, thereby ensuring visibility thereof.

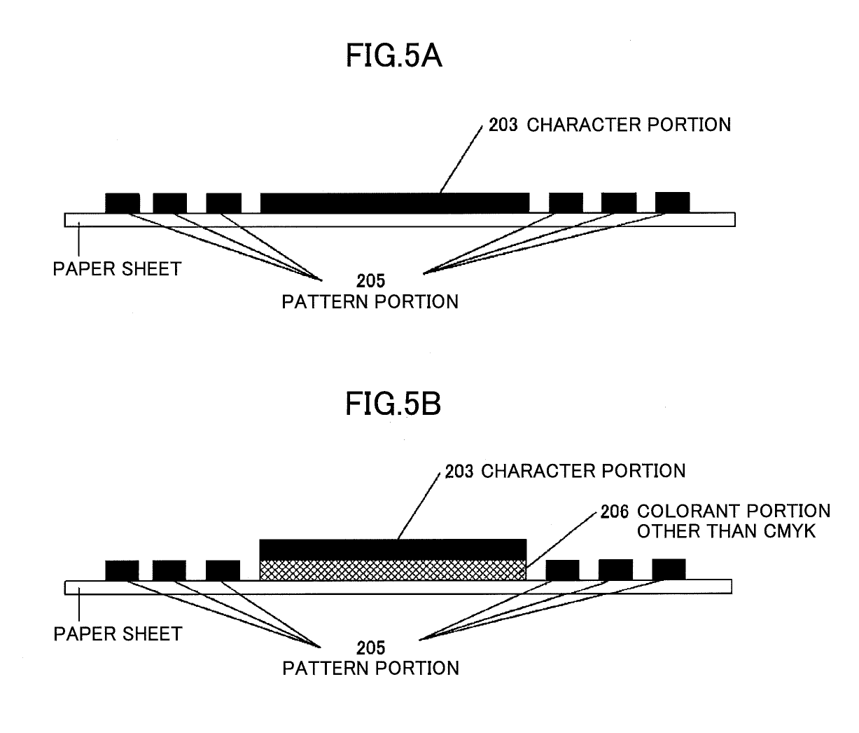

FIG. 5A and FIG. 5B are diagrams illustrating another example for improving visibility of a character in an embodiment of the present invention. When a chromatic portion is simply replaced with a specific pattern in a case where there is a character on the chromatic portion, there may not be a concentration difference between a character portion 203 and a pattern portion 205 as illustrated in FIG. 5A, and accordingly, visibility of the character may be degraded.

Hence, in an embodiment of the present invention, a colorant 206 other than CMYK, such as a transparent toner or a white toner, is placed onto only the character portion 203 as illustrated in FIG. 5B so that an amount of toner on the character portion 203 is more than an amount of toner on a surrounding pattern portion 205, whereby it is possible to improve the visibility of the character portion. Although a colorant other than CMYK is employed in the above-mentioned example, a CMYK toner(s) may be used.

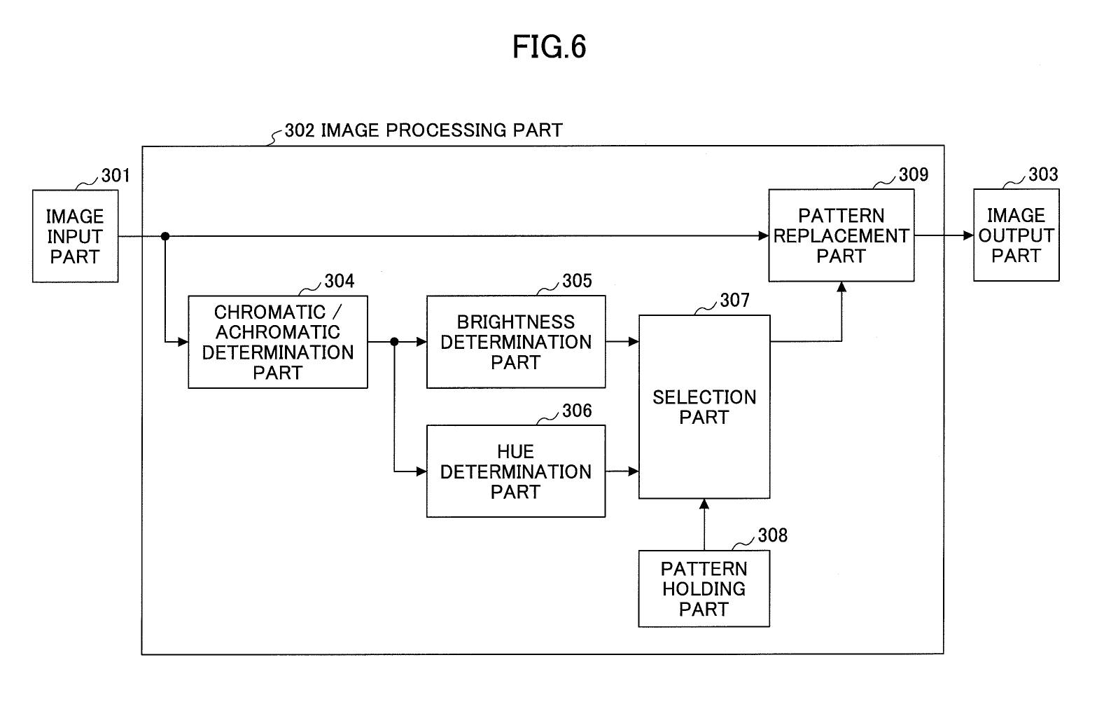

FIG. 6 illustrates a configuration of an image forming apparatus according to Practical Example 1 in an embodiment of the present invention. An image forming apparatus includes an image input part 301 such as an image reading device, an image processing part 302, and an image output part 303 for conducting image formation in an electrophotographic process. The image processing part 302 is configured to include a chromatic/achromatic determination part 304, a brightness determination part 305, a hue determination part 306, a selection part 307, a pattern holding part 308, and a pattern replacement part 309.

Color original document image data are inputted into the image processing part 302 by the image input part 301. The chromatic/achromatic determination part 304 determines whether inputted color original document image data are chromatic or achromatic, wherein when determination as being chromatic is made, the brightness determination part 305 determines which of three levels as illustrated in FIG. 3 the brightness of the original document image data corresponds to, and the hue determination part 306 determines which of four-divided hues, as illustrated in FIGS. 2 and 3, a hue of the original document image data corresponds to.

The above-mentioned chromatic/achromatic determination part 304, the brightness determination part 305, and the hue determination part 306 conduct determination processes for each picture element. For example, a flag (bit 1) is set at a picture element determined as being a chromatic picture element, and for a predetermined area (chromatic portion) composed of the picture elements determined as being chromatic picture elements, the brightness determination part 305 counts the number of picture elements at each of the three levels in the predetermined area and determines a brightness at a level with a maximum number of picture elements as being the brightness of the predetermined area of the original document image data. The hue determination part 306 counts the number of picture elements for each of four divided hues in the predetermined area and determines a hue with a maximum number of picture elements as being the hue of the predetermined area of the original document image data.

The pattern holding part 308 stores, for example, twelve kinds of patterns (101a-104c) dependent on brightness and hue as illustrated in FIG. 3. The selection part 307 selects a pattern corresponding to the determined brightness and hue of the predetermined area among the twelve kinds of patterns stored in the pattern holding part 308. Additionally, each of the brightness and the hue illustrated in FIG. 3 is managed by a 2-bit flag.

The pattern replacement part 309 replaces a chromatic portion in the original document image data with a selected pattern and the image output part 303 outputs original image data including the selected pattern monochromatically.

Additionally, the pattern holding part and selection part in the above-mentioned practical example may be configured to produce a pattern corresponding to a brightness and a hue automatically, instead of the pattern production part. Thereby, it is unnecessary to hold a pattern, and accordingly, it is possible to reduce an amount of memory.

### Practical Example 2

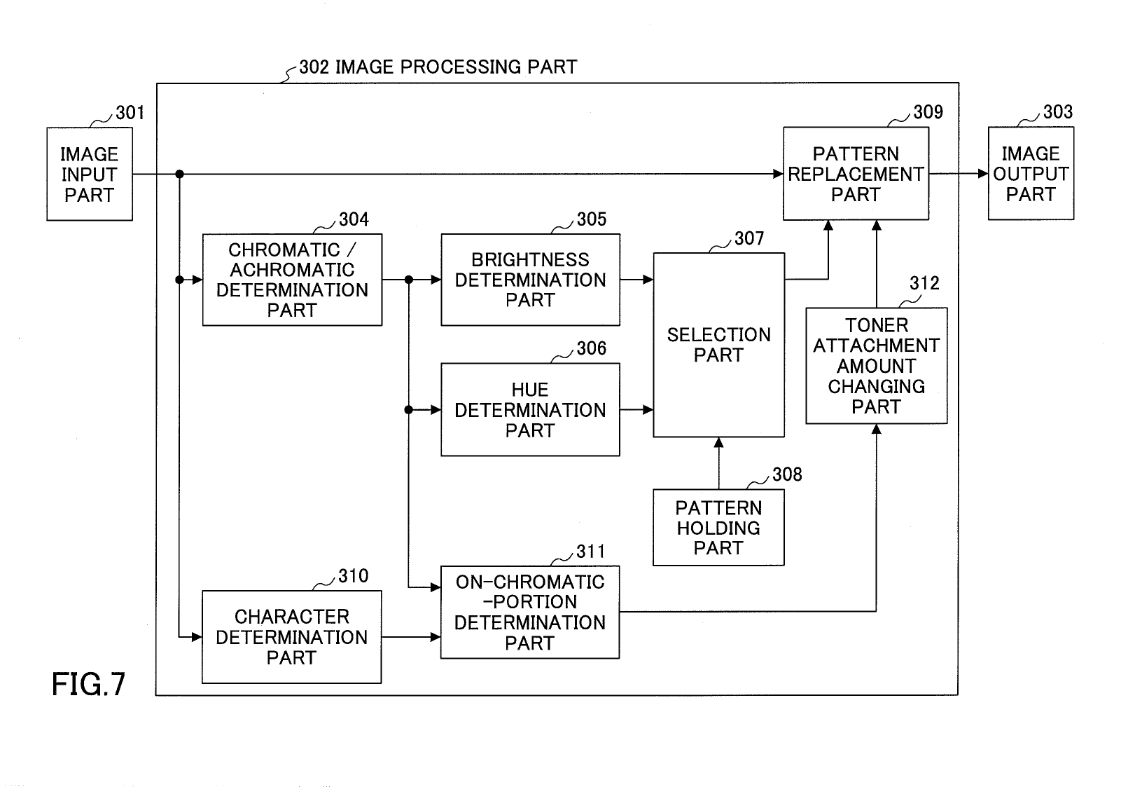

FIG. 7 illustrates a configuration of an image forming apparatus according to Practical Example 2 in an embodiment of the present invention. In an image processing part 302 in Practical Example 2, a character determination part 310, a character-on-chromatic-portion determination part 311, and a toner attachment amount changing part 312 are added to the configuration of Practical Example 1.

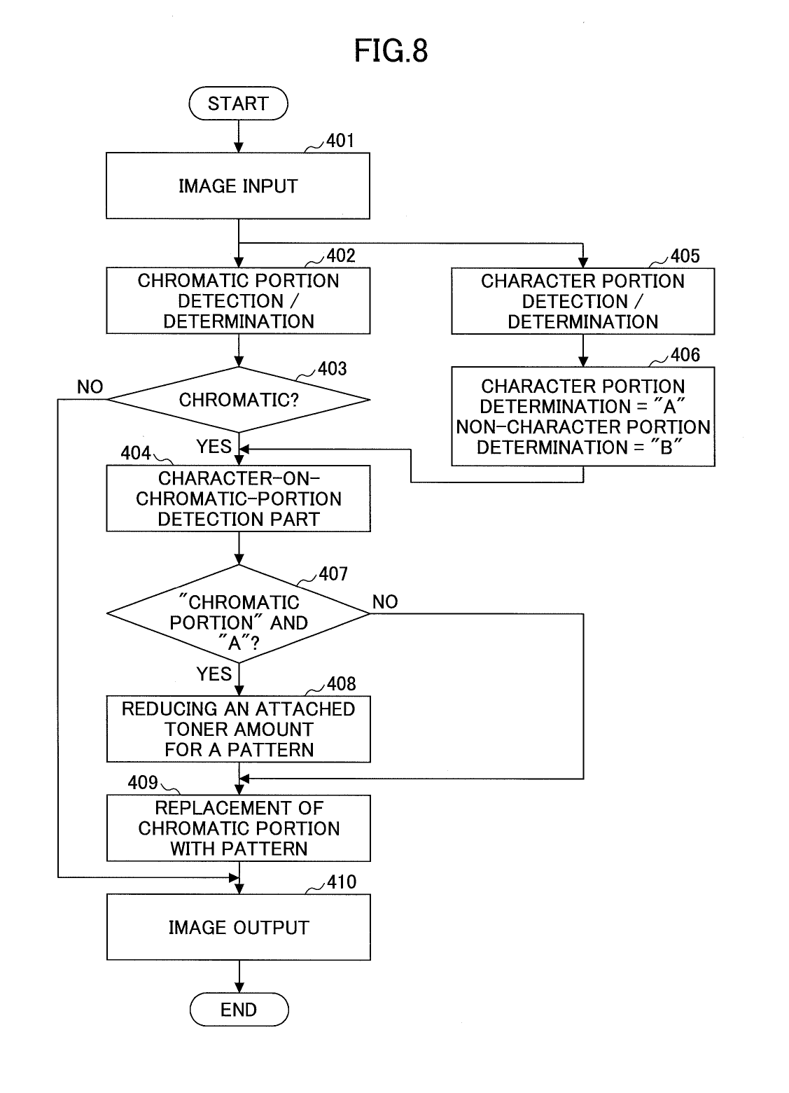

FIG. 8 illustrates a flowchart for a process in Practical Example 2. Color original document image data are inputted into the image processing part 302 by the image input part 301 (step 401). The chromatic/achromatic determination part 304 determines whether inputted color original document image data are chromatic or achromatic and specifies positions of a chromatic portion and an achromatic portion in the inputted image data (step 402). In parallel to such a process, the character determination part 310 detects a picture element for a character edge from the original document image data, thereby separating a character portion and a non-character portion, and specifying respective positions (steps 405 and 406). As a result of a determination conducted in the chromatic/achromatic determination part 304, pattern replacement is not conducted for an achromatic portion, and accordingly, an original image is outputted (step 410).

In a case where there is a character portion determined by the character determination part 310 on a chromatic portion determined by the chromatic/achromatic determination part 304, the character-on-chromatic-portion determination part 311 makes determination as being an area of a character-on-chromatic-portion (YES at steps 404 and 407), then the toner attachment amount changing part 312 changes an amount of toner to be used for a line or a dot for forming a replacing pattern on a chromatic portion to a setting being less than that at time of normal printing (step 408), then the pattern replacement part 309 replaces a chromatic portion in the original document image data with a selected pattern (step 409), and the image output part 303 outputs original document image data including a replaced pattern monochromatically (step 410). Furthermore, in the case of being a chromatic portion and non-character area (NO at step 407), such a chromatic portion is replaced with a predetermined pattern (step 409) as illustrated in Practical Example 1 and the original document image data are outputted as a monochromatic image (step 410). In a case of FIG. 5B, the toner attachment amount changing part 312, a colorant 206 other than CMYK such as a transparent toner or a white toner is placed onto only a character portion 203.

As mentioned above, when there is a character on a chromatic portion in Practical Example 2, an amount of an attached toner to be used for a replacing pattern is reduced to be less than that of a character portion, so that visibility thereof is ensured.

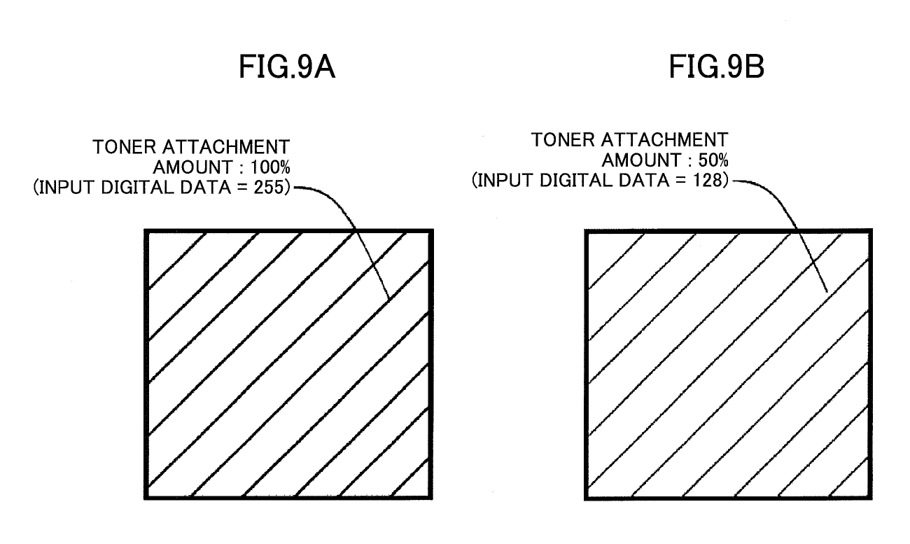

FIG. 9A and FIG. 9B are diagrams illustrating an example of reduction in an amount of an attached toner. Herein, a case where a pattern is preliminarily held in the pattern holding part 308 will be described. Usually, a line or dot for forming a pattern has been outputted as a solid one (input data=255) as illustrated in FIG. 9A to improve visibility thereof. However, when concentrations of a character and a line or dot are identical in a case where mixing with a character portion is conducted, the visibility of such a character may be degraded. Hence, a line or dot outputted as a solid one (input data=255) is thinned by an amount of attached toner being 50% (input data=128) as illustrated in FIG. 9B, whereby an amount of attached toner (100%) on a character portion and an amount of attached toner (50%) on a pattern portion are different so as to avoid degradation of visibility thereof.

In a case where a pattern is produced automatically, an amount of toner at an engine side of an image output part is regulated by software like a total amount regulation, or information is communicated to such an engine side and an amount of supplied toner is reduced for only a portion forming a line or dot whereby it is also possible to realize a similar effect.

### Practical Example 3

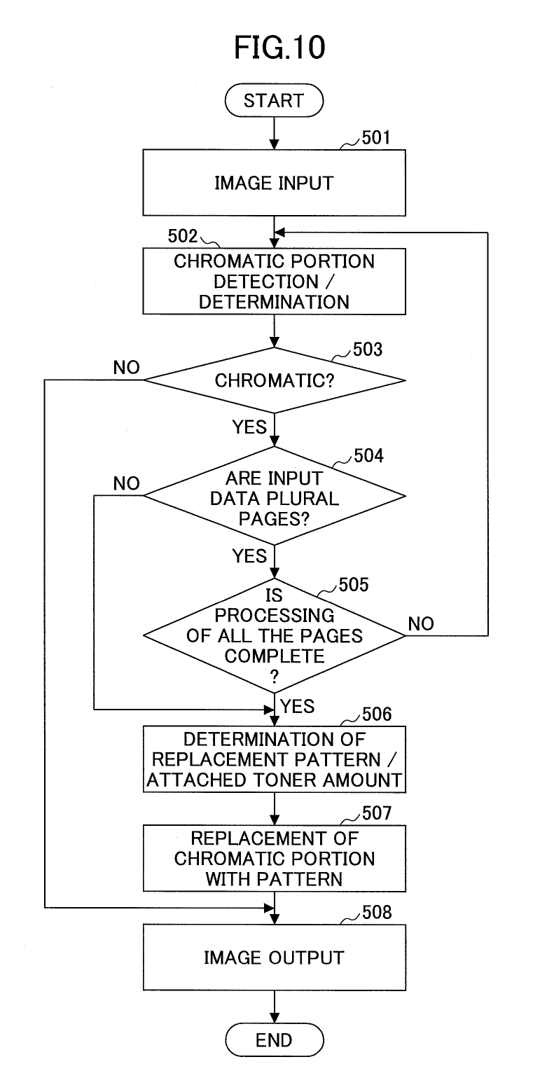

FIG. 10 illustrates a flowchart for a process in Practical Example 3. Practical Example 3 is a practical example in a case where input image data are composed of at least plural pages that are two or more pages.

The chromatic/achromatic determination part 304 determines chromatic or achromatic input image data (steps 502 and 503) and subsequently determines whether or not input data are provided on one page (step 504). In a case of one page, a chromatic portion is replaced with a predetermined pattern and a process is ended, similarly to the aforementioned Practical Example 1 or 2 (steps 506, 507, and 508). In a case of plural pages, the chromatic/achromatic determination part 304 determines whether or not a process of detection and determination for a chromatic portion in all the pages is completed (step 505). In a case of being not completed (No at step 505), a process of detection and determination of a chromatic portion on a next page is conducted (step 502). After a process for detection and determination of a chromatic portion in all the pages is completed (YES at step 505), a replacing pattern, an amount of toner necessary for pattern formation, etc., are determined (steps 506 and 507). Thereby, it is possible to implement a control in such a manner that a pattern density or a pattern concentration (an amount of attached toner) is not different among pages.

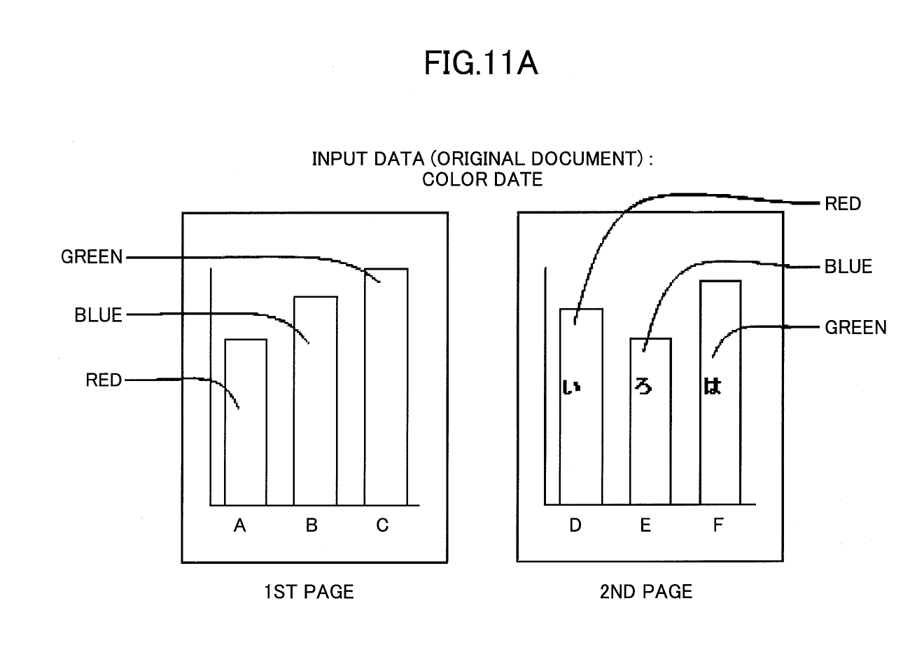

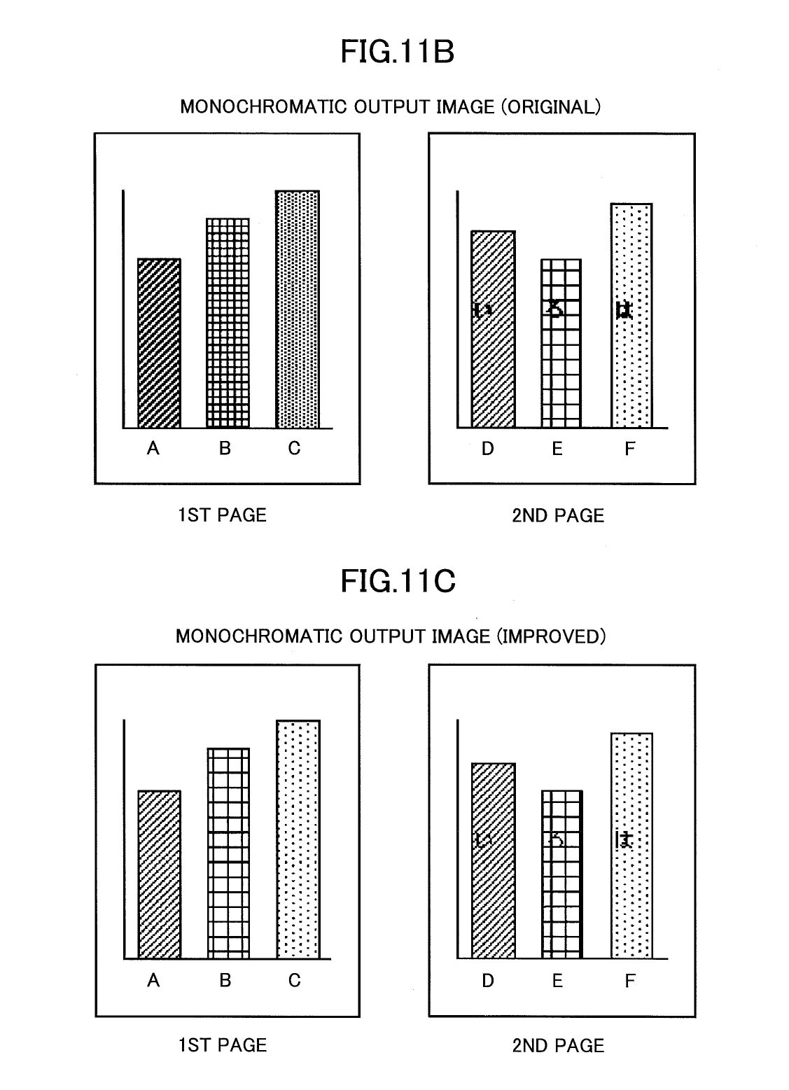

For example, a case where there are 2 pages of input data, as illustrated in FIG. 11A, will be described. FIG. 11B illustrates a case where a process described for Practical Examples 1 and 2 is applied for every one page. Herein, a pattern concentration may be changed, even between a first page and a second page, depending on whether or not there is a character on a colored background. That is, there are characters “ [symbol] ”, “ [symbol] ”, and “ [symbol] ” on colored backgrounds on the second page in FIG. 11A, and accordingly, pattern concentrations on the second page are less than those on the first page as illustrated in FIG. 11B.

When such a situation is viewed by a user, appearances on the first page and second page may be different, so that although color A on the first page and color D on the second page are an identical color (red), color B on the first page and color E on the second page are an identical color (blue), and color C on the first page and color F on the second page are an identical color (green), as illustrated in FIG. 11A and FIG. 11B, it may not be possible to determine, in data after printing, that such representations with identical colors are provided.

In Practical Example 3, it is seen that a method for integrating replacement of a color and pattern, a pattern density, a pattern concentration, etc., in a certain unit, or an identical rule, such as one printing job, aggregation printing such as 2 in 1 or 4 in 1 (wherein, for example, a process for copying 4 pages of an original document on one paper sheet is denoted by 4 in 1), or double face printing, is conducted for avoidance thereof, so that even if input data are separated into plural pages, an identical color is represented as illustrated in FIG. 11C. In an example of FIG. 11C, the selection part 307 selects, for each color on the first page, a pattern identical to a pattern selected for each corresponding color on the second page (a pattern with good visibility).

### Practical Example 4

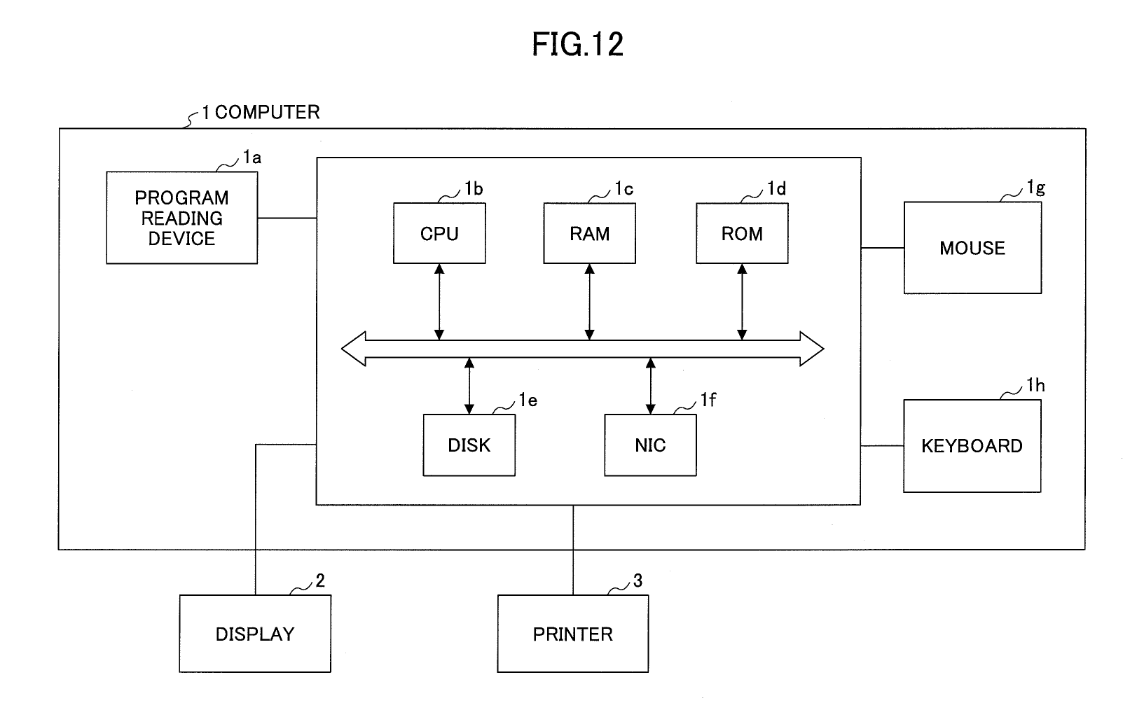

FIG. 12 illustrates an example of a configuration of hardware for an image processing device in a case where an embodiment of the present invention is implemented by software. A computer 1 includes a program reading device 1a, a CPU 1b for controlling an entire body, a RAM 1c to be used as a work area for the CPU 1b, etc., a ROM 1d for storing a control program for the CPU 1b, etc., a hard disk 1e, an NIC 1f for conducting communication with an instrument on a network, a mouse 1g, a keyboard 1h, a display 2 capable of displaying image data and inputting information thereto by a user touching a screen directly, and an image forming apparatus 3 such as a color printer. It is possible to realize the present image displaying device by, for example, a work station, a personal computer, etc.

In a case of such a configuration, it is possible for the CPU 1b to have functions of a chromatic/achromatic determination part, brightness determination part, hue determination part, selection part, pattern replacement part, character determination part, character-on-chromatic-portion determination part, and toner attachment amount changing part as illustrated in FIGS. 6 and 7, and it is possible to utilize a storage device such as the RAM 1c, the ROM 1d, or the DISK 1e when image data in a pattern holding part and an object to be processed, etc., are stored. Additionally, it is possible to provide a function of a process to be executed in the CPU 1b in a form of, for example, a software package, which is, specifically, an information recording medium such as a CD-ROM or a magnetic disk, and hence, a medium driving device (which is not in the figure) for driving the information recording medium when setting thereof is conducted, is provided in the example illustrated in FIG. 12.

As described above, it is also possible to implement an image processing method according to an embodiment of the present invention in a device configuration which causes a general-purpose computer system with a display, etc., to read a program recorded in an information recording medium such as a CD-ROM and causes a central processing unit of such a general-purpose computer system to execute image processing. In such a case, a program for executing image processing in an embodiment of the present invention, that is, a program to be used in a hardware system, is provided on a condition of being recorded in a recording medium. An information recording medium in which a program, etc., is recorded is not limited to a CD-ROM, and for example, a ROM, a RAM, a flash memory, or a magneto-optical disk may be employed. A program recorded in a recording medium is installed in a storage device incorporated in a hardware system, for example, a hard disk 700e, whereby it is possible to execute such a program so as to realize an image processing function. Furthermore, a program for realizing an image processing method, etc., in an embodiment of the present invention is not only provided in a form of a recording medium but may be provided, for example, from a sever by communication through a network.

[Appendix]

<An Illustrative Embodiment of an Image Forming Apparatus, an Image Forming Method, a Program, and a Recording Medium>

At least one illustrative embodiment of the present invention may relate to at least one of an image forming apparatus, an image forming method, a program, and a recording medium wherein a color original document image is converted into a monochromatic image and outputting thereof is conducted.

An object of at least one illustrative embodiment of the present invention may be to provide an image forming apparatus, an image forming method, a program, and a recording medium wherein an image is formed so that it is possible to identify shading of a color in an original document at the time of monochromatic printing.

At least one illustrative embodiment of the present invention may be an image forming apparatus for converting a color original document image into a monochromatic image and conducting outputting thereof, which is characterized by including a pattern holding part for holding a pattern with a predetermined shape whose density is different depending on a brightness of a color image and a control part for determining a brightness of a color area of the original document image, selecting a pattern with a predetermined shape corresponding to a determined brightness from the pattern holding part, replacing a color area of the original document image with a selected pattern with a predetermined shape and conducting outputting thereof.

Illustrative embodiment (1) is an image forming apparatus for converting a color original document image into a monochromatic image and conducting outputting thereof, wherein the image forming apparatus is characterized by including a pattern holding part for holding a pattern with a predetermined shape whose density is different depending on a brightness of a color image, and a control part for determining a brightness of a color area of the original document image, selecting a pattern with a predetermined shape corresponding to a determined brightness from the pattern holding part, replacing a color area of the original document image with a selected pattern with a predetermined shape, and conducting outputting thereof.

Illustrative embodiment (2) is an image forming apparatus for converting a color original document image into a monochromatic image and conducting outputting thereof, wherein the image forming apparatus is characterized by including a pattern holding part for holding a predetermined pattern with a shape and density which are different depending on a brightness and hue of a color image, and a control part for determining a brightness and hue of a color area of the original document image, selecting a predetermined pattern corresponding to a determined brightness and hue from the pattern holding part, replacing a color area of the original document image with a selected predetermined pattern, and conducting outputting thereof.

Illustrative embodiment (3) is the image forming apparatus as described in illustrative embodiment (1) or (2), characterized in that when there is a character area on the color area, the control part is set in such a manner that when replacement with the selected pattern with a predetermined shape or predetermined pattern and conducting outputting thereof are conducted, an amount of an attached toner required for image formation of the pattern with a predetermined shape or the predetermined pattern is less than an amount of an attached toner required for image formation of the character area.

Illustrative embodiment (4) is the image forming apparatus as described in illustrative embodiment (1) or (2), characterized in that when there is a character area on the color area, the control part is set in such a manner that when replacement with the selected pattern with a predetermined shape or predetermined pattern and conducting outputting thereof are conducted, a toner other than CMYK is added besides a toner required for image formation of the character area.

Illustrative embodiment (5) is the image forming apparatus as described in illustrative embodiment (4), characterized in that the toner other than CMYK includes a transparent toner or a white toner.

Illustrative embodiment (6) is the image forming apparatus as described in illustrative embodiment (1) or (2), characterized in that when the color original document image is an image to be processed in a predetermined unit including printing job data for plural pages, aggregation printing data, or double face printing data, the control part replaces a color area of the original document image with the selected pattern with a predetermined shape or predetermined pattern in accordance with an identical rule and conducts outputting thereof.

Illustrative embodiment (7) is an image forming method for converting a color original document image into a monochromatic image and conducting outputting thereof, wherein the image forming method is characterized by including a pattern holding step for holding a pattern with a predetermined shape whose density is different depending on a brightness of a color image, and a control step for determining a brightness of a color area of the original document image, selecting a pattern with a predetermined shape dependent on a determined brightness from the pattern holding step, replacing a color area of the original document image with a selected pattern with a predetermined shape, and conducting outputting thereof.

Illustrative embodiment (8) is a program for causing a computer to realize the image forming method as described in illustrative embodiment (7).

Illustrative embodiment (9) is a computer-readable recording medium wherein a program for causing a computer to realize the image forming method as described in illustrative embodiment (7) is recorded therein.

According to at least one illustrative embodiment of the present invention, it may be possible to conduct replacement with and outputting of a pattern with a density dependent on a brightness of a color area in an original document whereby it is possible to identify shading of a color of an original document at time of monochromatic printing.

Although the illustrative embodiments and specific examples of the present invention have been described with reference to the accompanying drawings, the present invention is not limited to any of the illustrative embodiments and specific examples and the illustrative embodiments and specific examples may be altered, modified, or combined without departing from the scope of the present invention.

The present application claims the benefit of priority based on Japanese Patent Application No. 2011-273258 filed on Dec. 14, 2011, the entire content of which is hereby incorporated by reference herein.

What is claimed is:

1. An image forming apparatus, comprising:
a pattern holding part configured to hold patterns with predetermined shapes and densities dependent on a brightness of a color image; and
a control part configured to determine a brightness of a color area of the color image, select a pattern with a predetermined shape corresponding to the determined brightness from the patterns held in the pattern holding part, replace the color area with the selected pattern with a predetermined shape, convert the color image with the selected pattern with a predetermined shape into a monochromatic image, and output the monochromatic image.

2. An image forming apparatus, comprising:
a pattern holding part configured to hold predetermined patterns with shapes and densities dependent on a brightness and a hue of a color image; and
a control part configured to determine a brightness and a hue of a color area of the color image, select a predetermined pattern corresponding to the determined brightness and hue from the predetermined patterns held in the pattern holding part, replace the color area with the selected predetermined pattern, convert the color image with the selected predetermined pattern into a monochromatic image, and output the monochromatic image.

3. The image forming apparatus as claimed in claim 1, wherein the control part is further configured in such a manner that when the color area includes a character area, an amount of a toner used for image formation of the selected pattern with a predetermined shape is less than an amount of a toner used for image formation of the character area.

4. The image forming apparatus as claimed in claim 2, wherein the control part is further configured in such a manner that when the color area includes a character area, an amount of a toner used for image formation of the selected predetermined pattern is less than an amount of a toner used for image formation of the character area.

5. The image forming apparatus as claimed in claim 1, wherein the control part is further configured in such a manner that when the color area includes a character area, a toner other than CMYK toners is added to a toner used for image formation of the character area.

6. The image forming apparatus as claimed in claim 2, wherein the control part is further configured in such a manner that when the color area includes a character area, a toner other than CMYK toners is added to a toner used for image formation of the character area.

7. The image forming apparatus as claimed in claim 5, wherein the toner other than CMYK toners includes a transparent toner or a white toner.

8. The image forming apparatus as claimed in claim 6, wherein the toner other than CMYK toners includes a transparent toner or a white toner.

9. The image forming apparatus as claimed in claim 1, wherein the control part is further configured in such a manner that when the color image includes printing job data for plural pages, aggregation printing data, or double face printing data, the color area is replaced with the selected pattern with a predetermined shape in accordance with a rule common to the data.

10. The image forming apparatus as claimed in claim 2, wherein the control part is further configured in such a manner that when the color image includes printing job data for plural pages, aggregation printing data, or double face printing data, the color area is replaced with the selected predetermined pattern in accordance with a rule common to the data.

11. An image forming method, comprising steps of:
holding a pattern with a predetermined shape and a density dependent on a brightness of a color image;
determining a brightness of a color area of the color image;
selecting a pattern with a predetermined shape corresponding to the determined brightness;
replacing the color area with the selected pattern with a predetermined shape;
converting the color image with the selected pattern with a predetermined shape into a monochromatic image; and
outputting the monochromatic image.

12. A non-transitory computer-readable recording medium storing a computer program configured to cause a computer to execute the image forming method as claimed in claim 11.
